(19) United States
(12) Patent Application Publication
(10) Pub. No.: US 2008/0049710 A1
(43) Pub. Date: Feb. 28, 2008

(54) METHOD AND APPARATUS FOR IMPROVING LINK RELIABILITY FOR CONTINUOUS PACKET CONNECTIVITY FOR HIGH SPEED PACKET ACCESS

(75) Inventors: Eldad M. Zeira, Huntington, NY (US); Alexander Reznik, Titusville, NJ (US); Paul Mariner, Brossard (CA); Christopher Cave, Verdun (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/843,252

(22) Filed: Aug. 22, 2007

Related U.S. Application Data
(60) Provisional application No. 60/839,862, filed on Aug. 24, 2006.

(51) Int. Cl. H04J 3/00; H04B 7/00

(52) U.S. Cl. 370/345; 455/522

(57) ABSTRACT

When a wireless transmit receive unit (WTRU) is using a reduced dedicated physical control channel (DPCCH) frame, the WTRU may periodically send a normal DPCCH frame. The WTRU may periodically increase the transmit power or send a normal DPCCH frame if there is a transmit power control (TPC) error or a downlink quality is below a threshold. When the WTRU implements DPCCH transmission gating, the WTRU may set a gating period based on the number of received TPC commands. The WTRU or Node-B may restore to a normal mode, if the link quality is below a threshold. The WTRU may periodically increase a transmit power. When a reduced signal-to-interference ratio (SIR) target is used for TPC, the WTRU may increase a transmit power, if the downlink power is not responsive. The WTRU or the Node-B may restore a normal SIR target if the link quality is below a threshold.

### CROSS REFERENCE TO RELATED APPLICATION

This application claims the benefit of U.S. Provisional Application No. 60/839,862 filed Aug. 24, 2006, which is incorporated by reference as if fully set forth.

### FIELD OF INVENTION

The present invention is related to wireless communication systems. More particularly, a method and apparatus for improving link reliability for continuous packet connectivity (CPC) for high speed packet access (HSPA) are disclosed.

### BACKGROUND

High speed downlink packet access (HSDPA) and enhanced dedicated channel (E-DCH) have been introduced to improve system capacity and data throughput. In a downlink, to support a large number of users for HSDPA, a fractional dedicated physical channel (F-DPCH) has also been introduced in third generation partnership project (3GPP) Release 6.

FIG. 1 shows a time slot format for an F-DPCH. The F-DPCH is a downlink dedicated physical control channel (DPDCH) that carries only transmit power control (TPC) bits generated at a physical layer.

CPC has been proposed to reduce interference and support a large number of users in an uplink. A new DPCCH timeslot format, (a reduced DPCCH timeslot), for the uplink has been proposed for CPC, as shown in FIGS. 2A-2C. When a wireless transmit/receive unit (WTRU) uses the reduced DPCCH timeslot for CPC, the WTRU transmits only TPC bits and pilot bits, rather than transmitting TPC bits, transport format combination index (TFCI) bits and, optionally, feedback indicator (FBI) bits. The WTRU may use the reduced DPCCH timeslot format in accordance with layer 3 (L3), layer 2 (L2) or layer 1 (L1) commands from a network, or in accordance with a pre-defined criteria. The TPC bits included in the reduced DPCCH timeslot received from the network will cause the WTRU to reduce its transmit power level to the lowest possible level that can maintain a link in order to support as many users as possible. Due to the reduced number of bits in the reduced DPCCH, this reduced transmit power level is lower than the minimum transmit power level in a normal mode. The reduced DPCCH timeslot format is preferably, but not necessarily, used in conjunction with the F-DPCH.

The problem with this proposed reduced DPCCH timeslot format is that TPC does not provide a means of detecting its own reception errors. In the absence of TFCI bits and data bits, the outer loop power control may not operate properly to keep the desired signal quality level, which helps determine the correct DPCCH power level . . . As a result, the DPCCH transmit power may be set too low or too high.

Setting the DPCCH transmit power too high reduces the number of users that can be supported in the uplink in the cell. Lowering the DPCCH transmit power increases the Node-B reception errors of TPC bits, which increases the downlink transmission power variance. This, in turn, increases downlink inter-cell interference in the network and also reduces the number of users. To avoid this problem, the system would likely employ a means to bias operation towards a higher DPCCH power.

While it is necessary to determine the correct transmission power for DPCCH, there is currently no mechanism available which results in a suboptimal system operation. In addition, there is no good way for the network to detect if the WTRU has ceased reception of the downlink channel. If this event goes undetected, it will be discovered when a normal mode is resumed, which causes an additional delay.

If a TPC-only downlink channel is used, (such as an F-DPCH), the behaviors of the WTRU and the Node-B would be similar, (i.e., both the WTRU and the Node-B may transmit at a low power). When this situation occurs, neither the WTRU nor the Node-B may detect the other's command to increase the transmission power, due to both transmitting at a low power. This is a link failure that can only be detected when the resumption of normal mode of operation is attempted.

In accordance with the proposed CPC, both uplink DPCCH transmission and downlink F-DPCH transmission may be gated to occur during only one out of a pre-determined number of sub-frames. The DPCCH transmission is turned off when no data is being transmitted to reduce DPCCH overhead.

FIG. 3 shows uplink DPCCH transmission with gating. When the uplink transmission gating is applied, the power control loop commands are rarely transmitted. This may lead to power control loop instability, which results in increased variance in both uplink and downlink transmit power. This variance will likely cause an increase in average transmission power so as to reduce probability of error and make it difficult for the network to detect link failure.

In accordance with the CPC proposal, the network is allowed to reduce the signal-to-interference ratio (SIR) target for uplink power control. The goal is to substantially reduce the uplink DPCCH transmission power by reducing the SIR target during idle traffic periods. With this scheme, the uplink transmit power will be driven down below a normal operating level. However, the WTRU transmit power may be driven down to the point where TPC commands can no longer be detected reliably, which will increase the variance of the downlink transmit power. Consequently, a higher than required downlink power may be allocated for the WTRU in question on the downlink DPCCH or F-DPCH, or that the power on the downlink DPCCH or F-DPCH may be reduced below a reliable level, resulting in a closed-loop failure.

### SUMMARY

A method and apparatus for improving link reliability for CPC for HSPA are disclosed. When a WTRU is operating in a reduced DPCCH timeslot mode, the WTRU may periodically send a normal DPCCH frame including TFCI bits. The WTRU may periodically increase the transmit power of the reduced DPCCH frame. The WTRU may transmit a normal DPCCH frame including TFCI bits if there is a TPC error in a downlink, or if a downlink quality is below a threshold. The Node-B may request to use a normal DPCCH frame including TFCI bits, if the uplink quality is below a threshold. When the WTRU implements a gated DPCCH transmission mode, the WTRU may set a gating period based on the number of received TPC commands. The WTRU may restore to the normal mode of operation, if the downlink quality is below a threshold. The Node-B may request to use the normal DPCCH operation if the uplink quality is below a threshold. The WTRU may periodically increase a transmit power of the uplink DPCCH frame. When an SIR target is substantially reduced, the WTRU may increase the transmit power of the DPCCH frame, if the transmit power on the downlink is not responsive to a TPC command or if the downlink quality is below a threshold. The Node-B may request to restore the SIR target to a normal value, if the uplink quality is below a threshold.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 shows a time slot format for an F-DPCH;

FIGS. 2A-2C show proposed DPCCH time slot formats;

FIG. 3 shows uplink DPCCH transmission with gating; and

FIG. 4 is a block diagram of a system which includes a WTRU and a network.

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node-B” includes but is not limited to a base station, a site controller, an access point (AP), or any other type of interfacing device capable of operating in a wireless environment.

FIG. 4 is a block diagram of a system 100 which includes a WTRU 110 and a network 120 including a Node-B 122. The WTRU includes a transmitter 112, a controller 114, a receiver 116, and an antenna 118. The transmitter 112 transmits a DPCCH frame, (either a normal DPCCH frame or a reduced DPCCH frame), to the Node-B 122. The transmitter 112 also implements DPCCH transmission gating and/or transmission power control in accordance with a TPC command from the Node-B 122, which may be generated based on a reduced SIR target. The receiver 116 monitors a downlink channel, (e.g., monitors a quality on a downlink DPCCH or other channels, transmit power on the downlink DPCCH, or the like). The controller 114 controls the transmitter 112 and DPCCH frame transmission in accordance with the present invention, which will be explained in detail hereinafter.

Table 1 shows alternative embodiments when a reduced DPCCH timeslot format is used. Table 2 shows alternative embodiments when uplink DPCCH gating is performed. Table 3 shows alternative embodiments when SIR target reduction is performed.

TABLE 1
When reduced DPCCH timeslot format is used,

the WTRU occasionally reverts to a normal mode and transmits a normal DPCCH frame;
the WTRU occasionally raises the transmit power of the reduced DPCCH frame on the uplink
DPCCH;
upon detection of a TPC error in the downlink based on the TFCI or data bits, the WTRU
reverts to the normal DPCCH frame;
upon detection of a TPC error, the WTRU transmits a special TFCI;
the WTRU sends a message requiring an acknowledgment to determine a possible link failure;
upon detection that the downlink radio link quality is below a predetermined threshold,
the WTRU restores to the normal DPCCH frame; or
if the uplink quality is below a predetermined threshold, the Node-B requests the WTRU
to restore transmission using the normal DPCCH frame.

TABLE 2
When uplink DPCCH gating is performed,

the Node-B transmits an F-DPCH prior to transmitting a DPCCH and the WTRU
is allowed to not respond to the downlink DPCCH transmission, if the downlink
TPC loop does not work properly;
the WTRU and/or the Node-B systematically adapt the gating period according to
the number of TPC commands in the same direction in the immediate past;
the WTRU and/or the Node-B use different step sizes when the uplink DPCCH
gating is in progress;
upon detecting that the radio link quality is below a predetermined threshold, the
WTRU restores to the normal DPCCH transmission mode; or
if the uplink quality is below a predetermined threshold, the Node-B requests the
WTRU to restore to the normal DPCCH transmission mode.

TABLE 3
When SIR target reduction is implemented,

the WTRU is informed that it is operating in a reduced SIR target mode and the
WTRU periodically raises its uplink transmit power by a predefined margin;
the WTRU monitors the downlink power and raises its uplink transmit power
when the WTRU estimates that the downlink power does not properly correspond
to its downlink TPC command sent by the WTRU;
the WTRU periodically changes its slot format while keeping the same power;
upon detecting that the radio link quality is below a predetermined threshold, the
WTRU signals to the Node-B that the SIR target should be restored to the value
used in normal operation; or
if the uplink quality is below a predetermined threshold, the Node-B restores the
SIR target to the value used in normal operation.

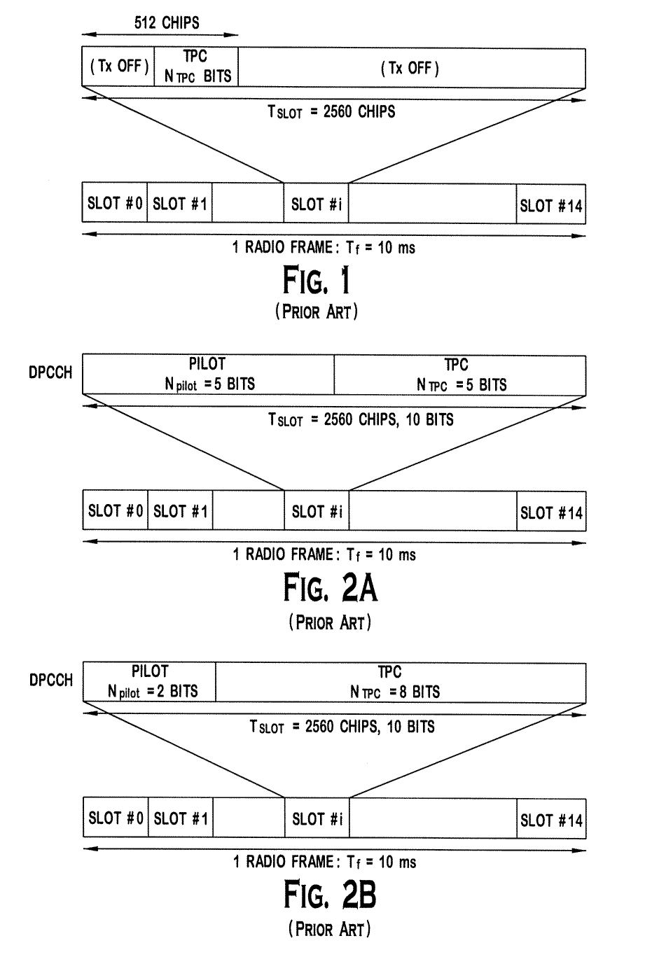

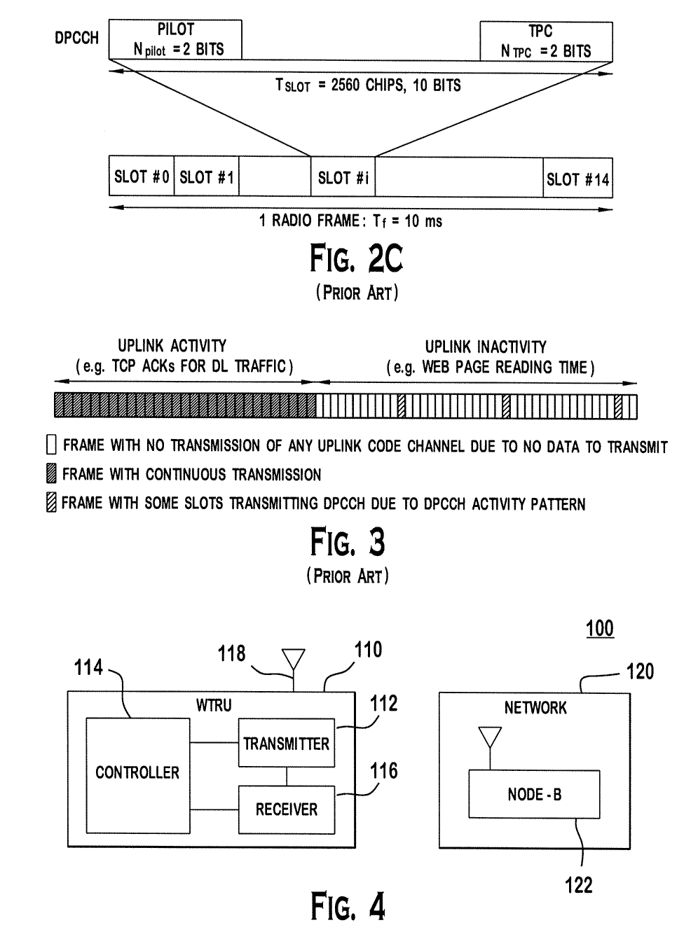

Improving link reliability for CPC while using a reduced DPCCH timeslot format is explained hereinafter. The transmitter 112 of the WTRU 110 transmits a reduced DPCCH frame including only TPC bits and pilot bits on the uplink DPCCH as shown in FIGS. 2A-2C.

In accordance with one embodiment, the WTRU 110 occasionally reverts to a normal mode and transmits a normal DPCCH frame including TFCI bits on the uplink DPCCH. Since estimating the uplink quality is much easier from the TFCI bits than from the TPC bits, the Node-B 122 may estimate a proper level of uplink transmit power based on the signal in the normal timeslot from the WTRU 110 and then sends a downlink TPC command to the WTRU 110 to adjust an uplink transmit power.

The schedule for transmitting the normal DPCCH frame may be indicated by the network 120, (e.g., by the Node-B 122), to the WTRU 110 via L1, L2 or L3 signaling. Alternatively, the schedule may be decided by both the WTRU 110 and the network 120 based on mutually known conditions. The TFCI bits in the normal timeslot are used by the Node-B 122 to estimate the uplink quality. This increases the reliability of the uplink power determination. The effect is that the uplink power deficiency will not cause an increase in the average downlink power or variance and peak downlink power as would be the case in the state of the art.

In accordance with another embodiment, the WTRU 110 occasionally raises the transmit power of the reduced DPCCH frame on the uplink DPCCH. The schedule for the transmit power increase is either known to, or determined by, the network 120, (e.g., the Node-B 122). The transmit power increase will guarantee proper detection of the TPC bits in the uplink DPCCH at the Node-B 122.

In accordance with yet another embodiment, if a downlink contains TFCI and data bits, upon detection of a TPC error in the downlink based on the TFCI or data bits, the WTRU 110 will revert to the normal DPCCH frame. The WTRU 110 may also increase the uplink transmit power for the normal DPCCH frame. Upon detection of the TFCI bits in the normal DPCCH frame on the uplink DPCCH while expecting none, the Node-B 122 recognizes that the WTRU 110 detected a TPC error, (which may mean that a block error rate (BLER) at the WTRU 110 is too high). The Node-B 122 may then increase the downlink transmit power regardless of the TPC bits included in the received normal DPCCH frame in order to guarantee the downlink QoS. In addition, since estimating the uplink quality is much easier from the TFCI bits than from the TPC bits, the Node-B 122 may estimate proper uplink transmit power based on the received normal DPCCH frame and send a downlink TPC command to the WTRU 110 to instruct the WTRU 110 to adjust its power as appropriate. The Node-B 122 may also use the information about the ability of the WTRU to properly demodulate the TPC bits in subsequent activations of the reduced DPCCH timeslot mode. For example, the Node-B 122 may allocate more power to the TPC bits for the particular WTRU.

In accordance with still another embodiment, upon detection of a TPC error, the WTRU 110 transmits a pre-configured special TFCI. The Node-B 122 detects the special TFCI and recognizes that a TPC error occurred. The Node-B 122 may then increase the downlink transmit power in order to guarantee the downlink QoS. In addition, the Node-B 122 may estimate the proper uplink transmit power based on the received special TFCI and send a downlink TPC command to the WTRU 110 to instruct the WTRU 110 to adjust its uplink transmit power as appropriate. The Node-B 122 may also use the information about the ability of the WTRU to properly demodulate the TPC bits in subsequent activations of the reduced DPCCH timeslot mode. As above, this may be used with the above described mechanisms, (for example, by increasing power allocated to TPC bits in subsequent activations of the reduced DPCCH timeslot mode). Detection of the WTRU's return to the normal mode to transmit data is simplified using this scheme.

In accordance with another embodiment, the WTRU 110 sends an L2 message requiring an acknowledgment to determine a possible link failure. For instance, an RLC message is generated using the RLC acknowledge mode, as, for example, required for signaling communication. If the receipt of the message is not acknowledged after a predefined number of attempts, a link failure is assumed. The content of the message is rather irrelevant in this case, and therefore either a special message may be defined or transmission of control information which needs to be signaled anyway would be scheduled to accommodate this “link checking” need as well.

In accordance with another embodiment, the WTRU 110 monitors the radio link quality in the downlink while operating with the reduced DPCCH frame. Upon detection that the downlink radio link quality is below a predetermined threshold for a predetermined period of time, the WTRU 110 restores to the normal DPCCH frame.

The WTRU 110 may determine the downlink quality based on the TPC field of the F-DPCH frame. If the downlink quality based on the TPC field of the F-DPCH frame received from a serving high speed downlink shared channel (HS-DSCH) cell is less than a predetermined threshold (Q_{BAD}) for a predetermined period of time (T_{BAD}), the WTRU 110 switches to the normal DPCCH frame. Q_{BAD} and T_{BAD} are configurable parameters. The quality threshold Q_{BAD} should be chosen to be higher or equal to the parameter, Q_{OUT}, to prevent a radio link failure. Similarly, the parameter T_{BAD} should be shorter than 160 ms+the value of timer T313 to prevent a radio link failure.

Alternatively, the WTRU 110 may determine the downlink quality based on either a high speed shared control channel (HS-SCCH) or a primary common control physical channel (PCCPCH) or a common pilot channel, (e.g., PCH). These channels contain a cyclic redundancy check (CRC). A correct reception indicates that the transmission aimed to the WTRU 110. The quality may then be estimated from the HS-SCCH or PCCPCH transmissions. If the quality on the HS-SCCH or the PCCPCH is below a predetermined threshold for a predetermined period of time, the WTRU 110 switches to the normal DPCCH frame to request the Node-B 122 to raise its power.

In accordance with another embodiment, the Node-B 122 determines the uplink quality while the WTRU 110 operates using the reduced DPCCH frame. If the uplink quality is below a predetermined threshold for a predetermined period of time, the Node-B 122 requests the WTRU 110 to restore transmission using the normal DPCCH frame. The Node-B 122 may send the request via the HS-SCCH. Alternatively, the Node-B 122 may send the request using L2 signaling.

For all embodiments stated hereinbefore, a radio link (RL) failure detection mechanism may be operated in the background. To limit the occurrence of failure it is preferable that the embodiments of the present stated hereinbefore be given sufficient time to work, thus preferably radio link failure detection time should be made longer.

A method for improving link reliability for CPC while uplink DPCCH gating is performed is explained hereinafter. The WTRU transmits DPCCH frames not continuously as shown in FIG. 3 when operating in a DPCCH gating mode. The uplink DPCCH transmissions are turned on and off in accordance with the gating period.

In accordance with one embodiment, the Node-B 122 transmits an F-DPCH prior to transmitting a DPCCH (pattern scheduling) and the WTRU 110 is allowed to not respond to the downlink DPCCH transmission, (i.e., not to follow up the F-DPCH transmission with a DPCCH burst of its own), if the downlink TPC loop does not work properly. If the Node-B 122 detects no response to the downlink F-DPCH transmission, the Node-B 122 recognizes that a TPC error occurs and may increase the downlink transmit power. Alternatively, the Node-B 122 may also decrease the gating period, (i.e., the WTRU 110 transmits more often or continuously). In this case, the WTRU 110 may also revert back to the normal mode, (i.e., non-gated mode). Alternatively, the Node-B 122 may use an HS-SCCH transmission, (in this case, the WTRU 110 is required to monitor in a normal mode) having a command to indicate to the WTRU to either increase it's transmission power or return to normal mode of operation. Alternatively, the HS-SCCH transmission may be followed by a packet on an HS-DPCH to increase the transmit power (L2 signal). The packet that is transmitted over HS-DPCCH can be a new L2, (e.g., MAC-layer indication), or L3, (e.g., RRC message), command that indicates to the WTRU to either increase it's transmission power or return to normal mode of operation.

In accordance with another embodiment, the above may become an RL failure mechanism, (e.g. if attempted without results), (i.e., if the procedure above fails to achieve desired results, RL failure is declared after a pre-defined number of attempts).

In accordance with yet another embodiment, the WTRU 110 and/or the Node-B 122 systematically adapt the gating period according to the number of TPC commands in the same direction in the immediate past. For example, if the last n TPC commands were in the same direction then apply a gating period of min(1, G/n), where G is the maximum gating period defined through radio resource control (RRC) signaling.

In accordance with another embodiment, the WTRU 110 and/or the Node-B 122 use different (larger) step sizes, (at least the step size for TPC UP command), when the uplink DPCCH gating is in progress to compensate for the less frequent uplink DPCCH transmission. The step sizes may be different between the TPC UP and TPC DOWN commands, and are specified through RRC signaling. This allows for faster recovery in case the channel conditions degrade at a fast rate. The TPC DOWN step size may be same to the non-gating value.

In accordance with another embodiment, the WTRU 110 monitors the radio link quality in the downlink while operating in an uplink DPCCH gating mode. Upon detecting that the radio link quality is below a predetermined threshold for a predetermined period of time, the WTRU 110 restores to the normal DPCCH transmission mode.

The WTRU 110 may determine the downlink quality based on the TPC field of the F-DPCH frame. If the quality on the TPC field of the F-DPCH frame received from a serving HS-DSCH cell is less than a predetermined threshold (Q_{BAD}) for a predetermined period of time (T_{BAD}), the WTRU 110 switches to the normal DPCCH transmission mode. Q_{BAD} and T_{BAD} are configurable parameters. The quality threshold Q_{BAD} should be chosen to be higher or equal to the parameter, Q_{OUT}, to prevent a radio link failure. Similarly, the parameter T_{BAD} should be shorter than 160 ms+the value of timer T313 to prevent a radio link failure. Alternatively, the WTRU 110 may determine the downlink quality based on either an HS-SCCH or a P-CCPCH.

In accordance with another embodiment, the Node-B 122 determines the uplink quality while the WTRU 110 operates in the gated DPCCH transmission mode. If the uplink quality is below a predetermined threshold for a predetermined period of time, the Node-B 122 requests the WTRU 110 to restore to the normal DPCCH transmission mode, (i.e., non-gated mode). The Node-B 122 may send the request via the HS-SCCH. Alternatively, the Node-B 122 may send the request using L2 signaling.

Improving link reliability for CPC while SIR target reduction is performed is explained hereinafter. The Node-B 122 uses the reduced SIR target for TPC. The WTRU uplink transmit power is determined based on a TPC command generated by the Node-B 122 based on the reduced SIR target.

In accordance with one embodiment, the WTRU 110 is informed that it is operating in a reduced SIR target mode (via L1 or L2 message) and the WTRU 110 periodically raises its uplink transmit power by a predefined margin. The schedule for the transmit power increase is either known to, or determined by, the network 120.

In accordance with another embodiment, the WTRU 110 monitors the downlink power and raises its uplink transmit power when the WTRU 110 estimates that the downlink power does not properly correspond to its downlink TPC command sent by the WTRU 110.

In accordance with still another embodiment, the WTRU 110 periodically changes its slot format, (i.e., the reduced DPCCH frame and the normal DPCCH frame), while keeping the same power.

In accordance with another embodiment, the WTRU 110 monitors the radio link quality in the downlink while operating in the reduced SIR target mode. Upon detecting that the radio link quality is below a predetermined threshold for a predetermined period of time, the WTRU 110 increases its uplink transmission power and signals to the Node-B 122 that the SIR target should be restored to the value used in normal operation.

The signaling of the request for the SIR target restoration may be achieved through L1 signaling. The WTRU 110 may send a DPCCH transmission with a special TFCI, or a reduced DPCCH frame having one or more bits to request an increase in the SIR target. Alternatively, the signaling for the request may be performed through L2 signaling. The WTRU 110 sends an enhanced medium access control (MAC-e) protocol data unit (PDU) to the Node-B 122 which includes a request an increase in the SIR target.

The WTRU 110 may determine the downlink quality based on the TPC field of the F-DPCH frame. If the quality on the TPC field of the F-DPCH frame received from a serving HS-DSCH cell is less than a predetermined threshold (Q_{BAD}) for a predetermined period of time (T_{BAD}), the WTRU 110 switches to the normal DPCCH transmission mode. Q_{BAD} and T_{BAD} are configurable parameters. The quality threshold Q_{BAD} should be chosen to be higher or equal to the parameter, Q_{OUT}, to prevent a radio link failure. Similarly, the parameter T_{BAD} should be shorter than 160 ms+the value of timer T313 to prevent a radio link failure. Alternatively, the WTRU 110 may determine the downlink quality based on either an HS-SCCH or a P-CCPCH.

In accordance with another embodiment, the Node-B 122 determines the uplink quality while the WTRU 110 operates in the reduced SIR target mode. If the uplink quality is below a predetermined threshold for a predetermined period of time, the Node-B 122 restores the SIR target to the value used in normal operation. The Node-B 122 may signal to the WTRU 110 to increase in SIR target so that the WTRU 110 may apply a power margin, or gradually increase the transmission power of the WTRU 110 using the inner loop power control mechanism. The Node-B 122 may send the request via the HS-SCCH. Alternatively, the Node-B 122 may send the request using L2 signaling.

Although the features and elements have been described in the preferred embodiments in particular combinations, each feature or element can be used alone without the other features and elements of the preferred embodiments or in various combinations with or without other features and elements of the present invention. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH; and
the WTRU periodically entering into a normal DPCCH timeslot mode to send a normal DPCCH frame including transmit format combination indicator (TFCI) bits to the Node-B.

2. The method of claim 1 further comprising:
the network generating a schedule for the WTRU to enter into the normal DPCCH timeslot mode, wherein the WTRU transmits the normal DPCCH frame based on the schedule.

3. The method of claim 1 further comprising:
the network and the WTRU generating a schedule for the WTRU to enter into the normal DPCCH timeslot mode based on a condition known to the WTRU and the network, wherein the WTRU transmits the normal DPCCH frame based on the schedule.

4. The method of claim 1 further comprising:
the Node-B estimating an uplink quality based on the normal DPCCH frame; and
the Node-B adjusting a transmit power for the WTRU on an uplink and a downlink based on the estimated uplink quality.

5. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH; and
the WTRU periodically increasing a transmit power for the reduced DPCCH frame.

6. The method of claim 5 further comprising:
the network generating a schedule for increase of the transmit power of the reduced DPCCH frame, wherein the WTRU increases the transmit power of the reduced DPCCH frame based on the schedule.

7. The method of claim 5 further comprising:
the network and the WTRU generating a schedule for increase of the transmit power of the reduced DPCCH frame based on a condition known to the WTRU and the network, wherein the WTRU increased the transmit power of the reduced DPCCH frame based on the schedule.

8. The method of claim 5 further comprising:
the Node-B estimating an uplink quality based on the reduced DPCCH frame with an increased transmit power; and
the Node-B adjusting a transmit power for the WTRU on an uplink and a downlink based on the estimated uplink quality.

9. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH; and
the WTRU receiving a downlink signal from the Node-B;
the WTRU determining whether there is a TPC error based on the downlink signal; and
the WTRU transmitting a normal DPCCH frame including transmit format combination indicator (TFCI) bits to the Node-B via the uplink DPCCH if there is a TPC error.

10. The method of claim 9 further comprising:
the Node-B increasing a transmit power for the WTRU on an uplink and a downlink when the Node-B receives the normal DPCCH frame.

11. The method of claim 9 further comprising:
the Node-B estimating an uplink quality based on the normal DPCCH frame; and
the Node-B adjusting a transmit power for the WTRU on an uplink and a downlink based on the estimated uplink quality.

12. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH;
the WTRU receiving a downlink signal from the Node-B;
the WTRU determining whether there is a TPC error based on the downlink signal; and
the WTRU transmitting a DPCCH frame including a special transport format combination indicator (TFCI) to the Node-B via the uplink DPCCH if there is a TPC error.

13. The method of claim 12 further comprising:
the Node-B increasing a transmit power for the WTRU on an uplink and a downlink when the Node-B receives the special TFCI.

14. The method of claim 12 further comprising:
the Node-B estimating an uplink quality based on the DPCCH frame including the special TFCI; and
the Node-B adjusting a transmit power for the WTRU on an uplink and a downlink based on the estimated uplink quality.

15. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH;
the WTRU monitoring a link quality on a downlink; and
the WTRU transmitting a DPCCH frame including transmit format combination indicator (TFCI) bits via the uplink DPCCH if the downlink quality is below a predetermined threshold for a predetermined period of time.

16. The method of claim 15 wherein the WTRU monitors the downlink quality based on at least one of TPC bits in a fractional dedicated physical channel (F-DPCH), a high speed shared control channel (HS-SCCH), and a primary common control physical channel (P-CCPCH).

17. The method of claim 15 wherein the predetermined threshold is not less than a parameter value defined for detecting a link failure.

18. The method of claim 15 wherein the predetermined period of time is shorter than 160 ms plus a value of a timer T313.

19. In a wireless communication system including a wireless transmit receive unit (WTRU) and a network including a Node-B, a method of improving link reliability for continuous packet connectivity (CPC) when the WTRU is operating in a reduced dedicated physical control channel (DPCCH) timeslot mode, the method comprising:
the WTRU entering into a reduced DPCCH timeslot mode so that the WTRU transmits a reduced DPCCH frame including only pilot bits and transmit power control (TPC) bits to the Node-B via an uplink DPCCH;
the Node-B monitoring a link quality on an uplink; and
the Node-B sending a request to the WTRU to enter a normal DPCCH timeslot mode so that the WTRU sends a normal DPCCH frame including transmit format combination indicator (TFCI) bits, if the Node-B determines that the uplink quality is below a predetermined threshold for a predetermined period of time.

20. The method of claim 19 wherein the Node-B sends the request via a high speed shared control channel (HS-SCCH).

21. The method of claim 19 wherein the Node-B sends the request via a layer 2 signaling message.

22. In a wireless communication system including a wireless transmit receive unit (WTRU) and a network including a Node-B, a method of improving link reliability for continuous packet connectivity (CPC) when the WTRU implements a gated dedicated physical control channel (DPCCH) transmission mode such that the WTRU sends uplink DPCCH frames not continuously, the method comprising:
the Node-B transmitting a fractional dedicated physical channel (F-DPCH) frame;
the WTRU determining whether a transmit power for the F-DPCH frame is responsive to a transmit power control (TPC) command; and
the WTRU sending a TPC command if the transmit power for the F-DPCH frame is responsive; otherwise the WTRU not responding to the F-DPCH frame.

23. The method of claim 22 further comprising:
the Node-B increasing a transmit power on a downlink if there is no response to the F-DPCH frame.

24. The method of claim 23 further comprising:
the Node-B increasing a transmit power on a downlink and reducing a gating period for uplink transmission if there is no response to the F-DPCH frame.

25. The method of claim 22 further comprising:
the Node-B sending a request to the WTRU to request a transmission using a non-gated mode so that the WTRU sends uplink DPCCH frames continuously if there is no response to the F-DPCH frame.

26. The method of claim 25 wherein the Node-B sends the request via a high speed shared control channel (HS-SCCH).

27. In a wireless communication system including a wireless transmit receive unit (WTRU) and a network including a Node-B, a method of improving link reliability for continuous packet connectivity (CPC) when the WTRU implements a gated dedicated physical control channel (DPCCH) transmission mode such that the WTRU sends uplink DPCCH frames not continuously, the method comprising:
counting the number of transmit power control (TPC) commands; and
if last n TPC commands were in the same direction, setting a gating period for implementing the gated DPCCH transmission mode to
$$min ( 1 , \frac{G}{n} ) ,$$
where G is a maximum gating period.

28. The method of claim 27 wherein a TPC step size is set to a different value when the uplink DPCCH gating is in progress.

29. The method of claim 28 wherein a TPC step size for a TPC UP command and a TPC step size for a TPC DOWN command are set differently.

30. In a wireless communication system including a wireless transmit receive unit (WTRU) and a network including a Node-B, a method of improving link reliability for continuous packet connectivity (CPC) when the WTRU implements a gated dedicated physical control channel (DPCCH) transmission mode such that the WTRU sends uplink DPCCH frames not continuously, the method comprising:
the WTRU monitoring a radio link quality on a downlink while operating in a gated DPCCH transmission mode; and
the WTRU restoring to a normal DPCCH transmission mode so that the WTRU sends uplink DPCCH frames continuously, if the radio link quality on the downlink is below a predetermined threshold for a predetermined period of time.

31. The method of claim 30 wherein the WTRU monitors the link quality based on at least one of TPC bits in a fractional dedicated physical channel (F-DPCH), a high speed shared control channel (HS-SCCH), and a primary common control physical channel (P-CCPCH).

32. In a wireless communication system including a wireless transmit receive unit (WTRU) and a network including a Node-B, a method of improving link reliability for continuous packet connectivity (CPC) when the WTRU implements a gated dedicated physical control channel (DPCCH) transmission mode such that the WTRU sends uplink DPCCH frames not continuously, the method comprising:
the Node-B monitoring an uplink quality; and
the Node-B sending a request to the WTRU to use a normal DPCCH transmission mode so that the WTRU transmits uplink DPCCH frames continuously, if the uplink quality is below a predetermined threshold for a predetermined period of time.

33. The method of claim 32 wherein the Node-B sends the request via a high speed shared control channel (HS-SCCH).

34. The method of claim 32 wherein the Node-B sends the request via a layer 2 signaling message.

35. In a wireless communication system including a wireless transmit receive unit (WTRU) and a network including a Node-B, a method of improving link reliability for continuous packet connectivity (CPC) when a signal-to-interference ratio (SIR) target for transmit power control (TPC) is substantially reduced, the method comprising:
the WTRU transmitting an uplink dedicated physical control channel (DPCCH) frame with a transmit power determined based on a TPC command that is generated by the Node-B using the reduced SIR target; and
the WTRU periodically increasing a transmit power of the uplink DPCCH frame.

36. The method of claim 35 further comprising:
the network generating a schedule for increase of the transmit power of the uplink DPCCH frame, wherein the WTRU transmits the uplink DPCCH frame with an increased transmit power based on the schedule.

37. The method of claim 35 further comprising:
the network and the WTRU generating a schedule for increase of the transmit power of the uplink DPCCH frame based on a condition known to the WTRU and the network, wherein the WTRU transmits the uplink DPCCH frame with an increased transmit power based on the schedule.

38. In a wireless communication system including a wireless transmit receive unit (WTRU) and a network including a Node-B, a method of improving link reliability for continuous packet connectivity (CPC) when a signal-to-interference ratio (SIR) target for transmit power control (TPC) is substantially reduced, the method comprising:
the WTRU transmitting an uplink dedicated physical control channel (DPCCH) frame with a transmit power determined based on a TPC command that is generated by the Node-B using the reduced SIR target;
the WTRU monitoring a transmit power on a downlink;
the WTRU increasing a transmit power of the uplink DPCCH frame, if the transmit power on the downlink is not responsive to a TPC command sent by the WTRU.

39. In a wireless communication system including a wireless transmit receive unit (WTRU) and a network including a Node-B, a method of improving link reliability for continuous packet connectivity (CPC) when a signal-to-interference ratio (SIR) target for transmit power control (TPC) is substantially reduced, the method comprising:
the WTRU transmitting an uplink dedicated physical control channel (DPCCH) frame with a transmit power determined based on a TPC command that is generated by the Node-B using the reduced SIR target;
the WTRU monitoring a downlink quality; and
the WTRU increasing a transmit power of the uplink DPCCH frame and sending a request to the Node-B to restore the SIR target to a normal value, if the downlink quality is below a predetermined threshold for a predetermined period of time.

40. The method of claim 39 wherein the WTRU monitors the downlink quality based on at least one of TPC bits in a fractional dedicated physical channel (F-DPCH), a high speed shared control channel (HS-SCCH), and a primary common control physical channel (P-CCPCH).

41. The method of claim 39 wherein the request is indicated by sending a special transport format combination indicator (TFCI) via the uplink DPCCH frame.

42. The method of claim 39 wherein the request is indicated by including a bit in a reduced DPCCH frame including TPC bits and pilot bits.

43. The method of claim 39 wherein the request is indicated by a special value in an enhanced medium access control (MAC-e) protocol data unit (PDU).

44. In a wireless communication system including a wireless transmit receive unit (WTRU) and a network including a Node-B, a method of improving link reliability for continuous packet connectivity (CPC) when a signal-to-interference ratio (SIR) target for transmit power control (TPC) is substantially reduced, the method comprising:
the WTRU transmitting an uplink dedicated physical control channel (DPCCH) frame with a transmit power determined based on a TPC command that is generated by the Node-B using the reduced SIR target;
the Node-B monitoring an uplink quality; and
the Node-B sending a request to the WTRU to restore the SIR target to a normal value, if the uplink quality is below a predetermined threshold for a predetermined period of time.

45. The method of claim 44 wherein the Node-B sends the request via a high speed shared control channel (HS-SCCH).

46. The method of claim 44 wherein the Node-B sends the request via a layer 2 signaling message.

47. A wireless transmit receive unit (WTRU) for improving link reliability for continuous packet connectivity (CPC) when the WTRU is operating in a reduced dedicated physical control channel (DPCCH) timeslot mode, the WTRU comprising:
a transmitter configured to transmit an uplink DPCCH frame to a Node-B via an uplink DPCCH; and
a controller configured to control transmission of the uplink DPCCH frame such that the transmitter transmits a reduced DPCCH frame including only pilot bits and transmit power control (TPC) bits and periodically transmits a normal DPCCH frame including transmit format combination indicator (TFCI) bits while the WTRU is in a reduced DPCCH timeslot mode.

48. The WTRU of claim 47 wherein the controller controls the transmitter to transmit the normal DPCCH frame based on a schedule generated by a network.

49. The WTRU of claim 47 wherein the controller is configured to generate a schedule for sending the normal DPCCH frame based on a condition known to the WTRU and a network, and control the transmitter to transmit the normal DPCCH frame based on the schedule.

50. A wireless transmit receive unit (WTRU) for improving link reliability for continuous packet connectivity (CPC) when the WTRU is operating in a reduced dedicated physical control channel (DPCCH) timeslot mode, the WTRU comprising:
a transmitter configured to transmit an uplink DPCCH frame to a Node-B via an uplink DPCCH; and
a controller configured to control transmission of the uplink DPCCH frame such that the transmitter transmits a reduced DPCCH frame including only pilot bits and transmit power control (TPC) bits and periodically increase a transmit power of the reduced DPCCH frame.

51. The WTRU of claim 50 wherein the controller controls the transmitter to transmit the reduced DPCCH frame with an increased transmit power based on a schedule generated by a network.

52. The WTRU of claim 50 wherein the controller is configured to generate a schedule for increasing the transmit power of the reduced DPCCH frame based on a condition known to the WTRU and a network, and control the transmitter to transmit the reduced DPCCH frame with an increased transmit power based on the schedule.

53. A wireless transmit receive unit (WTRU) for improving link reliability for continuous packet connectivity (CPC) when the WTRU is operating in a reduced dedicated physical control channel (DPCCH) timeslot mode, the WTRU comprising:
a transmitter configured to transmit an uplink DPCCH frame to a Node-B via an uplink DPCCH;
a receiver configured to monitor whether there is a transmit power control (TPC) error on a downlink; and
a controller configured to control transmission of the uplink DPCCH frame such that the transmitter transmits a reduced DPCCH frame including only pilot bits and TPC bits while the WTRU is in a reduced DPCCH timeslot mode, and transmit a normal DPCCH frame including transmit format combination indicator (TFCI) bits to the Node-B if there is a TPC error.

54. A wireless transmit receive unit (WTRU) for improving link reliability for continuous packet connectivity (CPC) when the WTRU is operating in a reduced dedicated physical control channel (DPCCH) timeslot mode, the WTRU comprising:
a transmitter configured to transmit an uplink DPCCH frame to a Node-B via an uplink DPCCH;
a receiver configured to determine whether there is a transmit power control (TPC) error on a downlink; and
a controller configured to control transmission of the uplink DPCCH frame such that the transmitter transmits a reduced DPCCH frame including only pilot bits and TPC bits while the WTRU is in a reduced DPCCH timeslot mode, and transmit a special transmit format combination indicator (TFCI) to the Node-B if there is a TPC error.

55. A wireless transmit receive unit (WTRU) for improving link reliability for continuous packet connectivity (CPC) when the WTRU is operating in a reduced dedicated physical control channel (DPCCH) timeslot mode, the WTRU comprising:
a transmitter configured to transmit an uplink DPCCH frame to a Node-B via an uplink DPCCH;
a receiver configured to monitor a downlink quality; and
a controller configured to control transmission of the uplink DPCCH frame such that the transmitter transmits a reduced DPCCH frame including only pilot bits and TPC bits while the WTRU is in a reduced DPCCH timeslot mode, and transmit a normal DPCCH frame including transmit format combination indicator (TFCI) bits via the uplink DPCCH if the downlink quality is below a predetermined threshold for a predetermined period of time.

56. The WTRU of claim 55 wherein the receiver monitors the downlink quality based on at least one of TPC bits in a fractional dedicated physical channel (F-DPCH), a high speed shared control channel (HS-SCCH), and a primary common control physical channel (P-CCPCH).

57. The WTRU of claim 55 wherein the predetermined threshold is not less than a parameter value defined for detecting a link failure.

58. The WTRU of claim 55 wherein the predetermined period of time is shorter than 160 ms plus a value of a timer T313.

59. A wireless transmit receive unit (WTRU) for improving link reliability for continuous packet connectivity (CPC) when the WTRU implements a gated dedicated physical control channel (DPCCH) transmission mode, the WTRU comprising:
a transmitter configured to transmit an uplink DPCCH frame to a Node-B via an uplink DPCCH; and
a controller configured to control transmission of the uplink DPCCH frame such that the transmitter transmits uplink DPCCH frames non continuously while the WTRU is in an gated DPCCH transmission mode, and configured to transmit a transmit power control (TPC) command to the Node-B only if a transmit power for an F-DPCH frame is responsive to a TPC command sent by the WTRU.

60. A wireless transmit receive unit (WTRU) for improving link reliability for continuous packet connectivity (CPC) when the WTRU implements a gated dedicated physical control channel (DPCCH) transmission mode, the WTRU comprising:
a transmitter configured to transmit an uplink DPCCH frame to a Node-B via an uplink DPCCH; and
a controller configured to control transmission of the uplink DPCCH frame such that the transmitter transmits uplink DPCCH frames non continuously while the WTRU is in an gated DPCCH transmission mode, and configured to count the number of transmit power control (TPC) commands and set a gating period for implementing the gated DPCCH transmission mode to
$$min ( 1 , \frac{G}{n} ) ,$$
where G is a maximum gating period if last n TPC commands were in the same direction.

61. The WTRU of claim 60 wherein a TPC step size is set to a different value when the uplink DPCCH gating is in progress.

62. The WTRU of claim 60 wherein a TPC step size for a TPC UP command and a TPC step size for a TPC DOWN command are set differently.

63. A wireless transmit receive unit (WTRU) for improving link reliability for continuous packet connectivity (CPC) when the WTRU implements a gated dedicated physical control channel (DPCCH) transmission mode, the WTRU comprising:
a transmitter configured to transmit an uplink DPCCH frame to a Node-B via an uplink DPCCH;
a receiver configured to monitor a downlink quality; and
a controller configured to control transmission of the uplink DPCCH frame such that the transmitter transmits uplink DPCCH frames non continuously while the WTRU is in an gated DPCCH transmission mode, and configured to restore to a normal DPCCH transmission mode so that the transmitter sends uplink DPCCH frames continuously if the downlink quality is below a predetermined threshold for a predetermined period of time.

64. The WTRU of claim 63 wherein the receiver monitors the link quality based on at least one of TPC bits in a fractional dedicated physical channel (F-DPCH), a high speed shared control channel (HS-SCCH), and a primary common control physical channel (P-CCPCH).

65. A wireless transmit receive unit (WTRU) for improving link reliability for continuous packet connectivity (CPC) when a signal-to-interference ratio (SIR) target for transmit power control (TPC) is substantially reduced, the WTRU comprising:
a transmitter configured to transmit an uplink dedicated physical control channel (DPCCH) frame to a Node-B via an uplink DPCCH, a transmit power for the uplink DPCCH frame being determined based on a TPC command that is generated by the Node-B using the reduced SIR target; and
a controller configured to periodically increase the transmit power of the uplink DPCCH frame.

66. The WTRU of claim 65 wherein the controller increases the transmit power of the DPCCH frame based on a schedule generated by the network.

67. The WTRU of claim 65 wherein the controller increases the transmit power of the DPCCH frame based on a schedule generated by the WTRU and the network based on a condition known to the WTRU and the network.

68. A wireless transmit receive unit (WTRU) for improving link reliability for continuous packet connectivity (CPC) when a signal-to-interference ratio (SIR) target for transmit power control (TPC) is substantially reduced, the WTRU comprising:
a transmitter configured to transmit an uplink dedicated physical control channel (DPCCH) frame to a Node-B via an uplink DPCCH, a transmit power for the uplink DPCCH frame being determined based on a TPC command that is generated by the Node-B using the reduced SIR target; and
a controller configured to increase a transmit power of the uplink DPCCH frame, if a transmit power on a downlink is not responsive to a TPC command sent by the WTRU.

69. A wireless transmit receive unit (WTRU) for improving link reliability for continuous packet connectivity (CPC) when a signal-to-interference ratio (SIR) target for transmit power control (TPC) is substantially reduced, the WTRU comprising:
a transmitter configured to transmit an uplink dedicated physical control channel (DPCCH) frame to a Node-B via an uplink DPCCH, a transmit power for the uplink DPCCH frame being determined based on a TPC command that is generated by the Node-B using the reduced SIR target;
a receiver configured to monitor a downlink quality; and
a controller configured to increase a transmit power of the uplink DPCCH frame and send a request to the Node-B to restore the SIR target to a normal value, if the downlink quality is below a predetermined threshold for a predetermined period of time.

70. The WTRU of claim 69 wherein the WTRU monitors the downlink quality based on at least one of TPC bits in a fractional dedicated physical channel (F-DPCH), a high speed shared control channel (HS-SCCH), and a primary common control physical channel (P-CCPCH).

71. The WTRU of claim 69 wherein the request is indicated by sending a special transport format combination indicator (TFCI) via the uplink DPCCH frame.

72. The WTRU of claim 69 wherein the request is indicated by including a bit in a reduced DPCCH frame including TPC bits and pilot bits.

73. The WTRU of claim 69 wherein the request is indicated by a special value in an enhanced medium access control (MAC-e) protocol data unit (PDU).
